(19) United States
(12) Patent Application Publication
(10) Pub. No.: US 2010/0327077 A1
(43) Pub. Date: Dec. 30, 2010

(54) Nozzles for Circulating Fluid in an Algae Cultivation Pond

(76) Inventors: Mehran Parsheh, Hayward, CA (US); Perry Young, Albany, CA (US); Stephen Strutner, San Jose, CA (US); Guido Radaelli, Oakland, CA (US)

Correspondence Address: CARR & FERRELL LLP, 120 CONSTITUTION DRIVE, MENLO PARK, CA, 94025, US

(21) Appl. No.: 12/495,690

(22) Filed: Jun. 30, 2009

(51) Int. Cl. B67D 5/08; B05B 1/00

(52) U.S. Cl. 239/71; 239/601; 239/589

(57) ABSTRACT

A nozzle for generating fluid flow in an algae cultivation pond is disclosed. The nozzle includes a surface forming a smooth flow path from an inlet to an outlet. The surface corresponds to a monotonically decreasing function from the inlet to the outlet. A ratio of an inlet cross-sectional area to an outlet cross-sectional area is greater than sixteen.

### FIELD OF INVENTION

The present invention relates generally to movement of fluid in an aquaculture, and more particularly to the use of nozzles and jets for initiating the circulation of fluid in an aquaculture, such as an algae cultivation pond.

### BRIEF SUMMARY OF THE INVENTION

Provided herein are exemplary nozzles for use in conjunction with jets for generating bulk motion of fluid in an algae cultivation pond. The jets may be used for circulating fluid in an algae cultivation pond, for generating local movement of fluid in an algae cultivation pond, or any combination thereof.

In a first aspect, a nozzle for generating fluid flow in an algae cultivation pond is disclosed. The nozzle includes a smooth surface forming a flow path from an inlet to an outlet. The surface corresponds to a monotonically decreasing function from the inlet to the outlet. A ratio of an inlet cross-sectional area to an outlet cross-sectional area is greater than sixteen.

In a second aspect, a nozzle for generating fluid flow in an algae cultivation pond is disclosed. The nozzle includes an inlet. The nozzle includes an outlet region including an outlet entry and an outlet exit. A ratio between an inlet cross-sectional area and an outlet region cross-sectional area is greater than sixteen. A cross-section of the outlet region corresponding to a triangle. The nozzle includes a smooth surface forming a flow path from the inlet to the outlet exit. The surface corresponds to a polynomial of order five or higher between the inlet and the outlet entry and corresponds to a convex edge between the outlet entry and the outlet exit. A ratio between a length of the surface and an inlet diameter ranges between 1.4 and 2.

In a third aspect, a nozzle for generating fluid flow in an algae cultivation pond is disclosed. An inlet is located on a first portion of an elongated body. An outlet is located on a second portion of the elongated body. A cross-section of the internal surface is circular at the inlet and rectangular at the outlet.

In a fourth aspect, a system for generating fluid flow in an algae cultivation pond is disclosed. The system includes at least one nozzle submerged below the surface of an algae cultivation pond. The nozzle is configured to initiate fluid flow in the algae cultivation pond. The nozzle includes a smooth surface forming a flow path from an inlet to an outlet. The surface corresponds to a monotonically decreasing function from the inlet to the outlet. A ratio of an inlet cross-sectional area to an outlet cross-sectional area is greater than sixteen. The system includes a manifold coupled to the nozzle and to a source of pressurized fluid. The manifold is configured to provide pressurized fluid to the nozzle. The system includes a processor and a computer-readable storage medium. The computer-readable storage medium has embodied thereon a program executable by the processor to perform a method for generating fluid flow in an algae cultivation pond. The computer-readable storage medium is coupled to the processor and the pressurized fluid source. The processor executes the instructions on the computer-readable storage medium to measure a velocity associated with the generated fluid flow in the algae cultivation pond and adjust an energy associated with the pressurized fluid.

The methods described herein may be performed via a set of instructions stored on storage media (e.g., computer readable media). The instructions may be retrieved and executed by a processor. Some examples of instructions include software, program code, and firmware. Some examples of storage media comprise memory devices and integrated circuits. The instructions are operational when executed by the processor to direct the processor to operate in accordance with embodiments of the present invention. Those skilled in the art are familiar with instructions, processor(s), and storage media.

### BRIEF DESCRIPTION OF THE DRAWINGS

FIG. 1 illustrates an exemplary jet circulation system in accordance with embodiments of the present invention.

FIG. 2 illustrates an embodiment of a jet array distribution system as described in the context of FIG. 1.

FIG. 3 illustrates an exemplary nozzle in accordance with embodiments of the present invention.

FIG. 4 illustrates an exemplary nozzle in accordance with embodiments of the invention.

FIG. 5 is a photograph of an expansion edge of a nozzle outlet region as disclosed in the context of FIGS. 3 and 4.

FIGS. 6A and 6B are photographs of a nozzle outlet region in accordance with FIGS. 3 and 4.

FIGS. 7A and 7B are photographs of a nozzle outlet region in accordance with FIGS. 3 and 4.

FIG. 8 illustrates an exemplary nozzle in accordance with FIGS. 3-4 and FIGS. 6-7.

FIG. 9 illustrates an exemplary nozzle in accordance with FIGS. 3-4 and FIGS. 6-7.

FIG. 10 illustrates the performance of exemplary nozzles in accordance with embodiments of the invention in efficiency experiments.

FIG. 11 illustrates the performance of exemplary nozzles in accordance with embodiments of the invention in flow experiments.

### DETAILED DESCRIPTION

Provided herein are exemplary systems, methods and media for generating fluid flow in an algae cultivation pond via the use of jets. Algae may be suspended in a fluid in the algae cultivation pond, e.g., algae cultivation pond fluid. The algae cultivation pond fluid may include for example, a mixture of fresh water and seawater, nutrients to promote algae growth, dissolved gases, disinfectants, waste products, and the like. The algae cultivation pond may exploit the natural process of photosynthesis in order to produce algal biomass and lipids for high-volume applications, such as the production of biofuels.

The systems, methods, and media presented herein generate jets via submerged nozzles. The resultant flow from the jet, or jet flow, may entrain algae cultivation pond fluid. In some embodiments, a co-flow associated with algae cultivation pond fluid may be continuously entrained into the jet flow and yield a substantially homogeneous mixture downstream from the jets. The jet flow may induce bulk movement, e.g., circulation of fluid in the algae cultivation pond.

The use of a jet circulation system in an algae cultivation pond may provide several unexpected advantages that in turn, may raise the productivity, e.g., algal yield per unit area, of the algae cultivation pond. For example, a jet circulation system may accommodate for head losses associated with flow velocities greater than or equal to 10 cm/s. The jet circulation system may promote uniform velocity in algae cultivation pond fluid, which may account for lower head losses in the algae cultivation pond. Uniform flow velocity in the algae cultivation pond may promote homogeneity in the algae cultivation pond fluid. Increased homogeneity may promote, for example, enhanced delivery of nutrients, dissolved gases such as carbon dioxide, and/or enhanced temperature distribution in the algae cultivation pond fluid. Uniform flow velocity may also reduce stagnation of fluid in the algae cultivation pond. Reduced stagnation of fluid associated with uniform flow velocity may prevent “dead zones,” or regions of low algal productivity.

The use of a jet circulation system may increase turbulence intensity and formation of large vortices in the algae cultivation pond fluid. Increases in turbulence intensity may promote the release of byproducts that may be dissolved in the algae cultivation pond fluid. For instance, algae produce oxygen during the course of photosynthesis, which is dissolved in solution upon production. Turbulence in the algae cultivation pond flow may promote the release of dissolved oxygen out of solution into the atmosphere. The externally imposed oxygen release due to turbulence of the algae cultivation pond fluid thus maintains the capacity of the algae cultivation pond fluid to absorb oxygen and may, in turn, promote algal photosynthesis. Thus, photosynthetic efficiency of the algae may increase and higher algal yields may be realized. In addition, the jets may provide enough kinetic energy to the algae cultivation pond fluid such that the increased turbulence intensity may be sustained far downstream of the jet. Thus, the release of oxygen and other benefits of increased turbulence may be global phenomena in the algae cultivation pond.

Increases in turbulence intensity may promote small-scale fluctuations in the flow velocity of algae cultivation pond fluid, which in turn increase the rate-of-rotation and fluctuating rate-of-strain of the flow. Such fluctuations in rate-of-strain promote the formation of eddies, which encourage vertical and lateral mixing of algae cultivation pond fluid. Increases in turbulence intensity may result in a turbulent boundary layer at the algal cell and enhance the rate of mass transfer to the algal cells, thereby enhancing the uptake of various nutrients and carbon dioxide. Additionally, increased fluctuating velocity may promote algae turnover at the surface, providing light exposure to algae at different levels in the culture.

In some embodiments, the entrainment of algae cultivation pond fluid into the jets may be maximized. Jet entrainment may be significantly increased by generating large scale coherent vortices, in particular, vortex rings. The formation of vortex rings may be induced by the roll-up of the jet shear layer. Increased roll-up of the jet shear layer may occur when the boundary layer in the nozzle from which the jet is issued is laminar. The presence of a higher flow velocity in the algae cultivation pond may affect the jet shear layer and therefore the roll-up of the jet shear layer.

The systems, methods, and media presented herein may make use of energy sources in order to provide kinetic energy to the jets. In some embodiments, it may be desirable to maximize the energy efficiency of the jet circulation system in order to minimize energy input. Alternatively, it may be desirable to maximize the turbulence intensity in the pond, which may involve increased energy consumption. The objectives of maximizing energy efficiency and maximizing turbulence may be reconciled and adjusted in real time. These parameters may involve adjustment of pond design, nozzle designs, and parameters such as desired velocity of fluid flow in the algae cultivation pond.

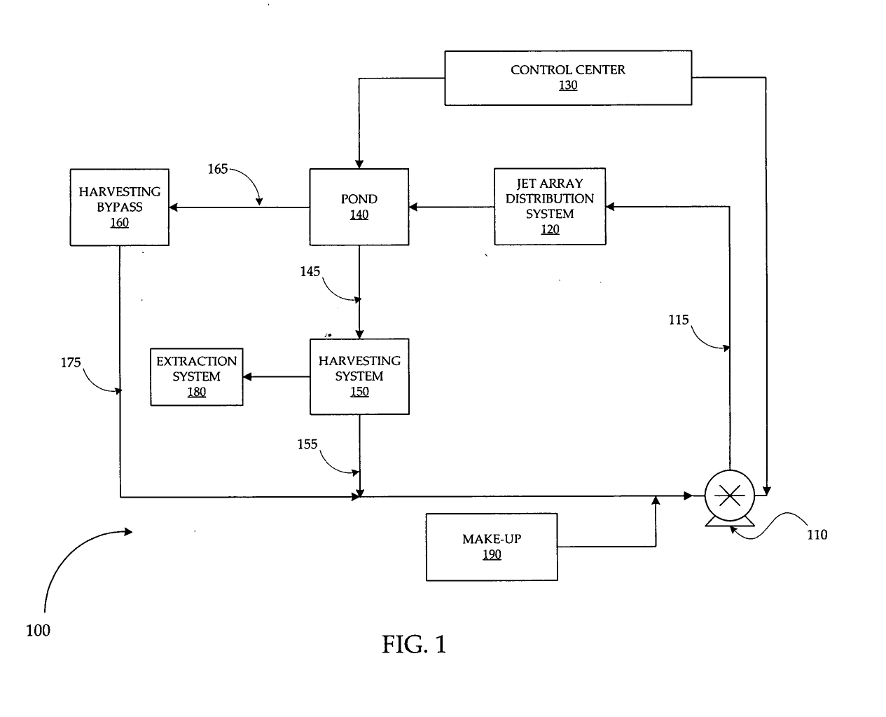

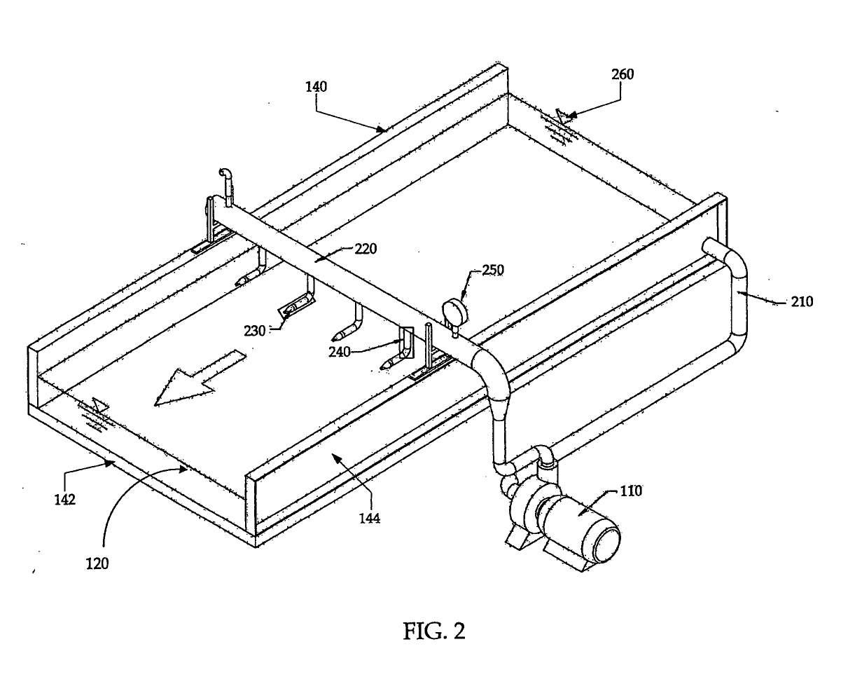

FIG. 1 illustrates an exemplary jet circulation system 100 in accordance with the embodiments presented herein. The jet circulation system 100 includes a pump 110, a jet array distribution system 120, a control center 130, a pond 140, a harvesting system 150, a harvesting bypass 160, an extraction system 180, and a make-up 190. The pump 110 may be, for example, a centrifugal pump. The jet array distribution system 120 is coupled to the pump 110 and configured to generate jets from pressurized fluid provided by the pump 110. Further components of the jet array distribution system 120 are illustrated and described in the context of FIG. 2. One skilled in the art will appreciate that any number of items 110-190 may be present in the jet circulation system 100. For example, any number of jet array distribution systems 120 may be present in a pond 140, and multiple ponds 140 may be present in jet circulation system 100. For all figures mentioned herein, like numbered elements refer to like elements throughout.

In some embodiments, fluid may be pumped from the pump 110 to the jet array distribution system 120 via a path 115. The pump 110 provides energy to move the fluid to jet array distribution system 120, thereby pressurizing the fluid. The jet array distribution system 120 may generate jets from the pressurized fluid and discharge the jets into the pond 140. The flow associated with the discharged jets, or jet flow, may have a higher dynamic pressure due to the increased energy generated by the pump 110. The fluid from the jets may entrain the algae cultivation pond fluid (not shown in FIG. 1) and produce a homogeneous mixture of algae cultivation pond fluid downstream of the jets. The jet flow, when brought in contact with the algae cultivation pond fluid, which has lower dynamic pressure, may promote circulation of the algae cultivation pond fluid.

The jet circulation system 100 may serve as a cultivation system for large quantities of algae. For instance, the jet circulation system 100 may be used to cultivate algae for large volume applications, such as in the production of biofuels. The jet circulation system 100 as such may be coupled to, for example, a harvesting system 150 and/or an extraction system 180. Algae may be harvested periodically from the pond 140, e.g., an algae cultivation pond. When harvesting is taking place, algae cultivation pond fluid may be routed from the pond 140 via a path 145. Upon harvesting, algae biomass may be routed to an extraction system 180 and algae cultivation pond fluid may be routed to the pump 110 via a path 155. Alternatively, the algae cultivation pond fluid may be discarded (not shown in FIG. 1).

In order to maintain a desired level of algae cultivation pond fluid, a harvesting bypass 160 may be available in jet circulation system 100. The harvesting bypass 160 may include an overflow component, which may act as a reservoir for surplus algae cultivation pond fluid (overflow component not shown in FIG. 1). The harvesting bypass 160 may be used to store excess algae cultivation pond fluid when harvesting is not taking place, such as during maintenance and repair, cleaning, or unfavorable weather conditions. In such scenarios, algae cultivation pond fluid may be routed via a path 165 to the harvesting bypass 160, and then via a path 175 to the pump 110.

Components may be added to jet circulation system 100 based on conditions that may play a role in algae cultivation and/or the needs of the particular genus or species of algae being cultivated. For instance, algae cultivation ponds having several acres of exposed surface area may lose large quantities of water via evaporation to the surrounding environment. Evaporation therefore may change concentrations of various nutrients and/or disinfectants in the algae cultivation pond fluid as well as the temperature of the remaining fluid. In order to maintain desired concentrations of these nutrients and/or disinfectants, a make-up 190 may be available in jet circulation system 100. The make-up 190 may introduce additional fresh water, seawater, disinfectants, and/or nutrients such as Aqua Ammonia, phosphorous solutions, and trace metals, such as Co, Zn, Cu, Mn, Fe and Mo in appropriate concentrations. In some embodiments, the make-up 190 may draw fluid from the harvesting bypass 160 (path not shown in FIG. 1).

The pump 110, the jet array distribution system 120, the pond 140, the harvesting system 150, the harvesting bypass 160, the extraction 180, and the make-up 190 may be controlled and/or otherwise monitored by the control center 130. The control center 130 may include any number of components, e.g., sensors, gauges, probes, control valves, servers, databases, clients, control systems and any combination of these (not shown in FIG. 1 for simplicity). The sensors, servers, databases, clients and so forth may be communicative with one another via any number or type of networks, for example, LAN, WAN, Internet, mobile, and any other communication network that allows access to data, as well as any combination of these. Clients may include, for example, a desktop computer, a laptop computer, personal digital assistant, and/or any computing device. The control center 130 may monitor and/or measure various parameters in the pond 140, such as pH, head velocity, the head loss associated with the pond flow velocity, temperature, nutrient concentration, concentration of disinfectant, algal density, dissolved oxygen content, turbidity, and the like. The control center 130 may display and/or generate reports based on the various parameters measured in the pond 140.

The control center 130 may store and/or execute software programs and/or instructions in order to take action based on the measured parameters. For instance, the control center 130 may execute a module which compares measured parameters from the pond 140 to a desired set of parameters. If the measured parameters are not within a predetermined range of the desired set of parameters (e.g., within ten percent), the control center 130 may make adjustments via execution of a set of instructions (e.g., a software routine), to any of the pump 110, the jet array distribution system 120, the pond 140, the harvesting system 150, the harvesting bypass 160, the extraction 180, and the make-up 190 in order to bring the measured parameters within the predetermined ranges. For instance, if the pH of the algae cultivation pond fluid drops to an undesirable level, e.g. a pH of 4, the control center 130 may provide instructions to the pump 110 to draw fluid from the make-up 190.

FIG. 2 illustrates an embodiment of jet array distribution system 120 as described in the context of FIG. 1. As shown in FIG. 2, portions of the jet array distribution system 120 may be situated in the pond 140. Components of jet array distribution system 120 may include an intake 210, a manifold 220, a nozzle 230, a downspout 240, and a gauge 250. FIG. 2 further illustrates algae cultivation pond fluid in the pond 140, a surface of which is indicated by a surface level marker 260. The nozzle 230 is submerged in the algae cultivation pond fluid. FIG. 2 further illustrates algae cultivation pond fluid in the pond 140, a surface of which is indicated by a surface level marker 260. The nozzle 230 is submerged in the algae cultivation pond fluid. The direction of circulation, or bulk flow of algae cultivation pond fluid, is indicated by 270. One skilled in the art will recognize that any number of components 210-260 may be present in jet array distribution system 120.

In some embodiments, algae cultivation pond fluid may be provided to the pump 110 via an intake 210 as shown in FIG. 2. The intake 210 may provide fluid in the algae cultivation pond to the pump 110, as shown in FIG. 2. Alternatively, the intake 210 may provide algae cultivation pond fluid from a component shown in FIG. 1, such as the harvesting system 150, the harvesting bypass 160, and/or the make-up 190.

Upon intake of algae cultivation pond fluid, the pump 110 may provide the algae cultivation pond fluid to the manifold 220. The pump 110 may provide energy to the algae cultivation pond fluid in order to transport the algae cultivation pond fluid to the manifold. Energy provided by the pump 110 may pressurize the algae cultivation pond fluid. The manifold 220 may distribute the pressurized algae cultivation pond fluid to the nozzles 230. One skilled in the art will recognize that the manifold 220 may be configured to provide algae cultivation pond fluid to any number of nozzles 230 and not just to four nozzles 230 as shown in FIG. 2. For instance, a single nozzle 230 may provide circulation in the algae cultivation pond.

The nozzles 230 may generate jets from the pressurized algae cultivation pond fluid (jets not shown in FIG. 2). A flow associated with the jets may provide kinetic energy to a pond flow in the algae cultivation pond. Per the “Law of Continuity” and “Law of Conservation of Energy” the flow in the pond, which includes the jet flow and the entrained co-flow, obtains a velocity from the jet flow. The kinetic energy of the jet flow translates into a higher static pressure. Since the pond flow has a free surface, as indicated by surface level marker 260, the higher static pressure translates into a head, which thereby initiates and/or maintains circulation of algae cultivation pond fluid in the algae cultivation pond 140.

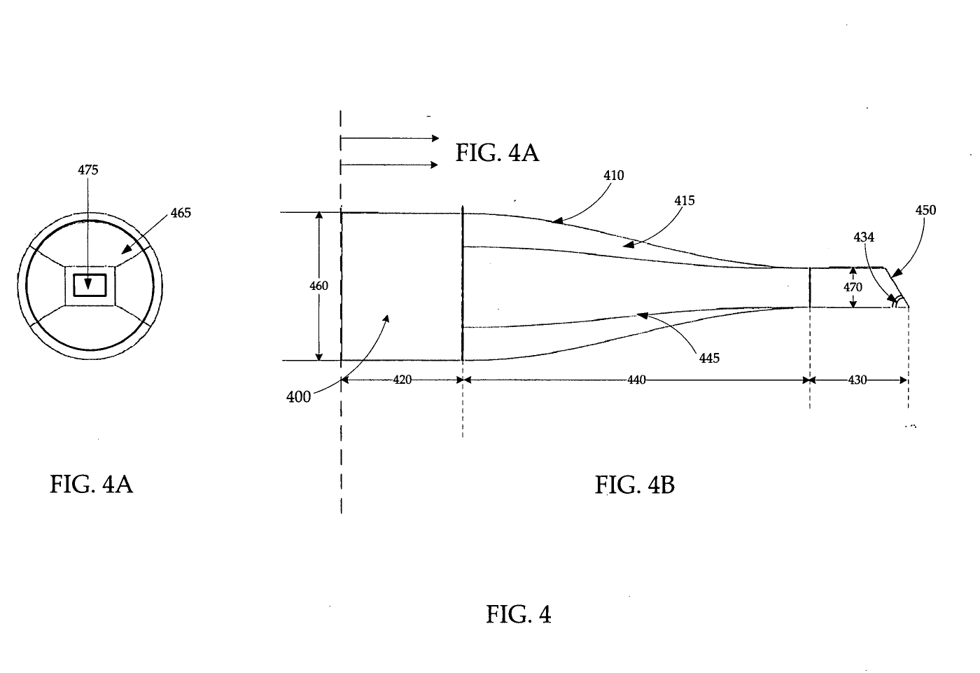

The flow associated with the jets, e.g., jet flow, may entrain the co-flow into the jets downstream of the nozzles 230. The entrainment of the co-flow into the jet flow may allow for distribution of nutrients, dissolved gases, minerals, and the like. In some embodiments, the jet flow may result from a single jet from a nozzle 230. Alternatively, the jet flow may result from an array of jets generated from the jet array distribution system 120 and be based on a placement of nozzles relative to each other. An exemplary nozzle array is further shown in FIG. 4.

The nozzles 230 may be placed at any flow depth in the pond 140. Flow depth may be characterized as a perpendicular distance between a free surface of the algae cultivation pond fluid as indicated by surface level marker 260, and the floor 142. Flow depth may be measured immediately downstream of the jets. A preferred range for flow depth may range from ten to thirty centimeters. Nozzle depth may be characterized as a perpendicular distance between a free surface of the algae cultivation pond fluid as indicated by surface level marker 260, and an outlet of a nozzle 230. A nozzle depth may be characterized relative to the flow depth, e.g., the nozzle depth may be halfway between the free surface of the algae cultivation pond fluid and the floor 142. In such characterizations, the nozzle depth may be characterized as in, or approximately in, the “middle” of the flow depth. An exemplary nozzle depth for the nozzles 230 in the jet array distribution system 120 may range from seven to fifteen centimeters from the free surface of the algae cultivation pond fluid in the pond 140 to the nozzle outlet. Nozzle depth may play a role in the formation of large vortex rings and promote the entrainment of the co-flow into the jet flow.

Nozzle depth may play a role in determining nozzle spacing, or the distance between two nozzles. Nozzle spacing may be measured between outlets of two individual nozzles 230. The nozzles 230 in FIG. 2 are shown at substantially the same nozzle depth and approximately equally spaced from one another. The spacing between individual nozzles 230 may range from twenty to fifty centimeters. Nozzle spacing may be determined empirically and/or analytically based on the design of the pond 140 and other factors described more fully herein.

The nozzles 230 may include nozzles of any design that may be configured to issue a submerged jet. The designs of the individual nozzles 230 may play a role in properties associated with the resultant jet flow, e.g., vortex ring formation, flow velocities, entrainment, and turbulence intensity. For instance, the formation of vortex rings may be affected by the depth of each nozzle 230. The nozzles may therefore be viewed as individual units, which may be added, removed, and/or otherwise manipulated in real time in order to generate a desired resultant jet flow.

The nozzles 230 may be selected based on flow characteristics. For instance, a laminar boundary layer between fluid in the nozzles 230 and interior surfaces of the nozzles 230 (not shown in FIG. 2) from which a jet is issued may promote the formation of vortex rings in the algae cultivation pond fluid. Since the formation of vortex rings in the algae cultivation pond fluid may facilitate entrainment of the co-flow of the algae cultivation pond fluid into the jet flow, ranges of jet flow velocities may be maintained such that a laminar boundary layer is maintained in the nozzles 230. With respect to the embodiments discussed in FIGS. 1 and 2, the ranges of flow velocities may be empirically determined and programmable into a set of instructions that are executable by the control center 130.

In some embodiments, the manifold 220 may provide the pressurized algae cultivation pond fluid to the nozzles 230 via optional spouts 240. The spouts 240 may be useful when the manifold is placed above the pond 140 and the nozzles 230 are submerged in the algae cultivation pond fluid as shown in FIG. 2. A plurality of configurations of the manifold 220 beyond those shown in FIG. 2 may be implemented. For instance, the manifold 220 and the nozzles 230 may be submerged in the algae cultivation pond 140. In such embodiments, the manifold 220 may be placed parallel to the configuration shown in FIG. 2, but along the floor 142 of the algae cultivation pond, or buried in the floor 142 of the algae cultivation pond (placement not shown in FIG. 2). Alternatively, the manifold 220 may be placed along a wall 144 of the algae cultivation pond (placement not shown in FIG. 2). In addition, several manifolds 220 may be coupled to the pump 110 and placed at various depths in the algae cultivation pond.

Any number and/or type of gauges and/or sensors 250 may be used to measure various parameters in the jet array distribution system 120. For example, pressure sensors may be coupled to the manifold 220 to measure static pressure in the manifold 220. Flowmeters may be used to measure flow rate in the manifold 220 to estimate the velocity of the jet at the outlet of any of the nozzles 230. The gauges 250 may be coupled to the control center 130, which may store and/or display data associated with the gauges 250. The gauges 250 may be coupled to the control center 130, which may execute algorithms to determine parameters such as flow rate, head loss, temperature, pH, concentration of dissolved gases, turbidity, turbulence characteristics, and the like.

The jet array distribution system 120 may be used in conjunction with an algae cultivation pond of any design. The algae cultivation pond may include any body of water that may be used for the purpose of cultivating algae. For instance, the jet array distribution system 120 may be applied to open-air raceway ponds used in the cultivation of Dunaliella or Spirulina, flumes and/or algae channels.

The jet array distribution system 120 may be customized based on the design of the algae cultivation pond and/or the needs of the particular genus or species of algae being cultivated therein. For instance, the pond 140 may be characterized by a frictional head loss associated with a range of pond velocities. In order to promote circulation in the pond 140, the pump 110 may provide energy to the jets. As such, the nozzles 230 may be organized in an array such that the resulting jet array, and resultant jet flow from the jet array, overcomes the frictional head loss associated with the pond 140.

Jet flow properties may additionally be influenced by the interactions of individual jets downstream of the nozzles. As such, the nozzles 230 may be organized into arrays in order to achieve various objectives downstream of the nozzles. These objectives may include maximizing energy efficiency, minimizing jet entrainment distance, maximizing turbulence of the fluid flow in the algae cultivation pond, minimizing the effects of “dead zones,” generating energetic vortices, and any combination of these. An exemplary linear nozzle array is shown in FIG. 2, with the four nozzles in approximately the same depth in the pond 140.

The nozzles 230 may be immobile and therefore form a static array. Alternatively, the array may be dynamic. For example, the nozzles 230 may be mobile and therefore various configurations of arrays may be arranged in real-time based on a desired resultant jet flow. In addition, the manifold 220 may be configured to provide pressurized algae cultivation pond fluid to all of the nozzles 230, or to selected nozzles 230 based on a desired jet and/or resultant jet flow. The arrangement of arrays may be managed at the control center 130. The control center 130 may execute instructions to manipulate and arrange various arrays based on a set of criteria, which may include, for example, a desired resultant jet flow, a desired ratio between a resultant jet flow and a co-flow in the algae cultivation pond, and the like.

The number of jets forming the jet array may be affected by the design of the particular algae cultivation pond. For instance, the number may be determined based on one of a flow depth of the algae cultivation pond, a desired distance between two jets, a jet diameter (based on characteristics of a cross section of a nozzle from which the jet is issued), a co-flow velocity in the algae cultivation pond, a desired ratio between pond flow and jet flow, and any combination thereof. For instance, a distance of thirty centimeters between the nozzles 230 may be desired in order to maximize jet entrainment.

The orientation of the nozzles 230 with respect to the direction of circulation may play a role in forming a desired resultant jet flow. For instance, the array of nozzles 230 shown in FIG. 2 is substantially horizontal, with each nozzle substantially parallel to the direction of circulation, indicated by the arrow 270. As such, the horizontal may be characterized as the direction of bulk flow, or circulation, in the algae cultivation pond. The nozzles may be oriented toward the floor 142 of the pond 140 such that the angle of the nozzle, and therefore the angle of the issued jet, is negative with respect to the horizontal. Alternatively, the angle of the nozzle may be angled away from the floor 142 such that the angle of the issued jet is positive with respect to the horizontal.

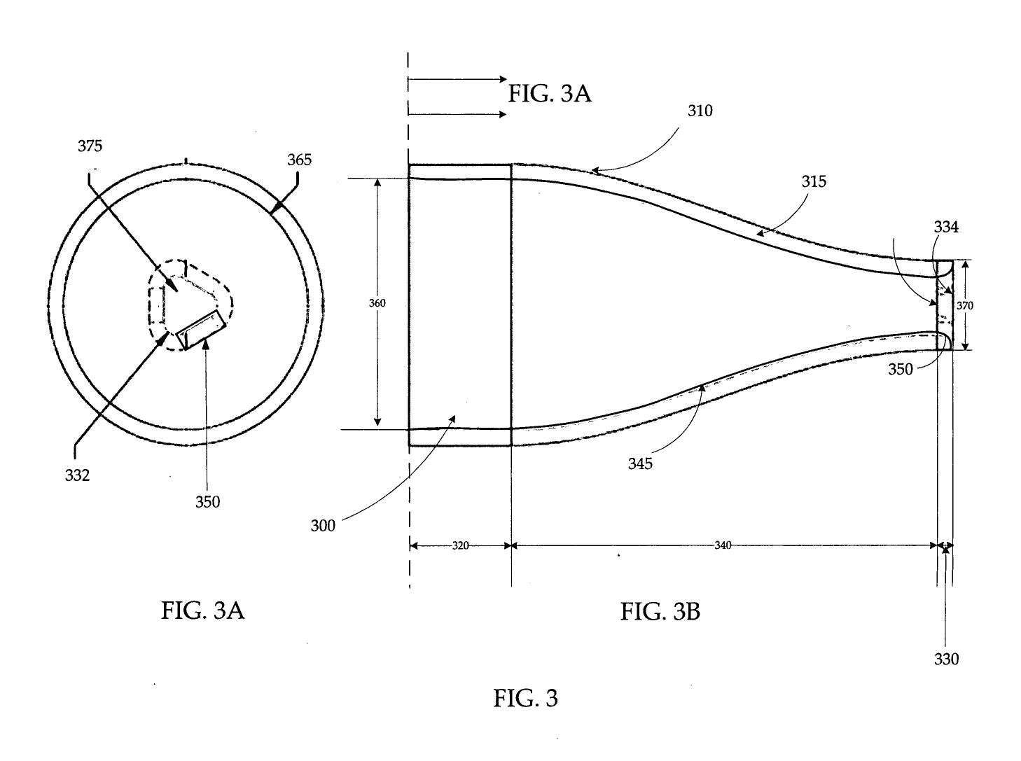

FIGS. 3A and 3B illustrate two cross-sectional views of an exemplary nozzle 300 for generating fluid flow in an algae cultivation pond. The exemplary nozzle 300 may be incorporated into embodiments of the invention presented herein, for instance, as a nozzle 230 as discussed in the context of FIG. 2. The inlet 320 of the nozzle 300 may be coupled to a pressurized fluid source, such as the pump 110. The outlet region 330 of the nozzle 300 may be submerged in the pond 140, thereby discharging a submerged jet into the pond 140.

The nozzle may include a nozzle body 310 forming the external surface of the nozzle 300, an inlet 320, an outlet region 330 with an outlet entry 332 and an outlet exit (e.g., discharge orifice) 334, a flow path 340 situated between the inlet 320 and the outlet region 330, which is bounded by a surface 345 that forms the internal surface of the nozzle 300, and an expansion edge 350. A wall 315 may separate the nozzle body 310 and the surface 345.

FIG. 3A illustrates an axial cross-section view of the nozzle 300 as viewed from the inlet 320. As shown, the profile of the nozzle 300 in the axial direction varies in shape along the nozzle body 310. At the inlet 320, the surface 345 has a substantially circular cross-section, as indicated by inlet cross-sectional area 365. This may facilitate coupling of the nozzle to a manifold, such as the manifold 220, or other conduit. At the outlet region 330, the profile of the nozzle is substantially triangular, as indicated by outlet cross-sectional area 375. The profile in the outlet region 330 shown in FIG. 3A substantially conforms to an equilateral triangle. One skilled in the art will recognize that any triangular profile such as isosceles or scalene, with any combination of angles, for instance, a right triangle, may be used in place of an equilateral triangle. The design of the outlet region 330 may be empirically determined based on flow parameters in the pond 140 and the pond design.

The contraction ratio, e.g., a ratio between the cross-sectional area of the inlet 320 and the cross-sectional area of the outlet region 330 may play a role in energy efficiency of the nozzle 300. For instance, a contraction ratio of greater than sixteen may generate jets with energetic vortices with lower initial energy input. In some embodiments, a contraction ratio ranging from sixteen to twenty-five is preferred.

FIG. 3B illustrates a longitudinal cross-sectional view of the nozzle 300, which may be useful in visualizing the flow path of pressurized fluid from the inlet 320 to the outlet exit 334. The nozzle body 310 may be elongated, as shown. The nozzle body 310 and the surface 345 may be characterized in terms of contours. In the inlet 320, the contour of the nozzle body 310 substantially conforms to that of the surface 345, as indicated by the substantially uniform thickness of the wall 315. At the inlet 320, the contour of the surface 345 is flat, or substantially parallel to a horizontal dimension. The inlet 320 may form an extension to a conduit such as the manifold 220 or the spouts 240 in FIG. 2, and the inlet 320 may maintain and extend the direction of flow into the nozzle 300 without substantial contraction of the flow path 340. From a three-dimensional perspective, the surface 345 may therefore correspond to a hollow cylinder in the inlet 320.

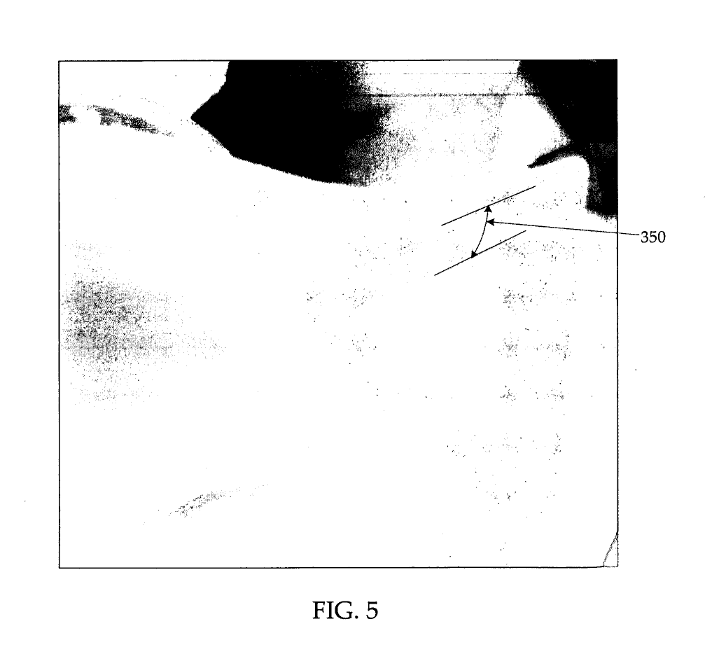

Unlike the inlet region 320, in the outlet region 330, the contours characterizing the nozzle body 310 and the surface 345 may not substantially conform to one another. The contour of the nozzle body 310 in the outlet region 330 is flat, as in the inlet 320. The surface 345, however, corresponds to an expansion edge 350, or convex edge, between the outlet entry 332 and the outlet exit 334. The expansion edge 350 may correspond to a fillet, forming a smooth transition point between the flow in the nozzle 300 and the issued jet. The expansion edge 350 forms an expansion of the fluid flow path in the outlet region 330, e.g., the cross-sectional area of the flow path 340 increases from the outlet entry 332 to the outlet exit 334 via the expansion edge 350. The surface 345, as such, may progressively join the nozzle body 310 and form a corner at the outlet exit 334. As such the thickness of the wall 315 approaches zero at the outlet exit 334. An alternate view of the expansion edge 350 is shown in FIG. 5.

Intermediate to the inlet 320 and the outlet region 330, the flow path 340 in the nozzle 300 contracts sharply. The surface 345 corresponds to the nozzle body 310 in the flow path 340, as is indicated by the substantially uniform thickness of the wall 315 in the flow path 340. The contour of the nozzle body 310 may correspond to a monotonically decreasing function intermediate to the inlet 320 and the outlet entry 332. In some embodiments, the contour may correspond to a sigmoidal, or “s-shaped” curve. The contour may be characterized and/or approximated by a polynomial series, of fourth order or higher, preferably a fifth-order polynomial. The surface 345 may include at least one inflection point. In some embodiments, the surface 345 may be smooth in order to reduce energy loss due to friction inside the nozzle 300.

In some embodiments, the surface 345 intermediate to the inlet 320 and the outlet region 330 may include a contour corresponding to a polynomial of fourth order or higher. Nozzles 300 which include contours corresponding to fourth and higher-order polynomials may be characterized by certain benefits. For instance, smooth acceleration and deceleration of fluid in the nozzle 300 from the inlet 320 to the outlet region 330 may result in reduced energy losses. The flow in the nozzle 300, e.g., core flow, may be characterized by low turbulence and a uniform velocity profile. Additionally, the contour may facilitate the formation of a thin relaminarized boundary layer.

An exemplary fifth-order polynomial may be characterized as follows:

$$y = {ax}^{5} + {bx}^{4} + {cx}^{3} + {dx}^{2} + ex + f$$

$$Where \text{:}$$

$$a = \frac{( 3 n - 3 m )}{{( l )}^{5}}$$

$$b = \frac{- 2.5 ( 3 n - 3 m )}{{( l )}^{4}}$$

$$c = \frac{1.67 ( 3 n - 3 m )}{{( l )}^{3}}$$

$$d = 0$$

$$e = 0$$

$$f = m / 2$$

and l is the nozzle contracting length (e.g., length of the nozzle between two inflection points), m is the diameter of the inlet 320 and n is the diameter of the outlet region 330.

The nozzle 300 may be optimized to produce large scale coherent vortices, in particular, vortex rings in the jet flow with decreased energy input. For instance, in addition to the features mentioned above, the nozzle 300 may feature a high contraction ratio. With respect to the nozzle 300, an inlet diameter 360 and outlet diameter 370 are shown in FIG. 3B. The inlet diameter 360 and outlet diameter 370 may be used as points of reference in the inlet 320 and in the outlet region 330 in order to determine cross-sectional areas of the inlet 320 and the outlet region 330, respectively. Contraction ratios of greater than sixteen may increase the efficiency of the nozzle 300. In some embodiments, contraction ratios ranging from sixteen to twenty-five may be preferable.

Contraction ratios for the nozzle 300 may vary based on the cross-sectional area determined in the outlet region 330. For instance, the outlet diameter 370 is shown in FIG. 3B is the diameter of the nozzle 300 at the outlet exit 334. However, the outlet diameter 370 may be measured at any cross-section of the nozzle 300 in the outlet region 330. The outlet diameter may be measured at the outlet entry 332, or any intermediate cross-section between the outlet entry 332 and the outlet exit 334.

Alternatively, the nozzle 300 may be optimized for energy efficiency. For instance, energy efficiency may be based on the ratio of energy used to circulate flow in an algae cultivation pond (e.g., the pond 140) and energy input to a nozzle (e.g., the nozzle 300). The ratio between the length of the nozzle flow path, e.g., the distance between the nozzle inlet and the nozzle outlet along the surface 345, and the diameter of the nozzle inlet at the inlet 320, may play a role in generating jets of high efficiency. Ratios may range between 1.4 and 2, with a preferred ratio of about 1.7.

FIGS. 4A and 4B illustrate two cross-sectional views of an exemplary nozzle 400. The exemplary nozzle 400 may be incorporated into embodiments of the invention presented herein, for instance, as a nozzle 230 as discussed in the context of FIG. 2. The inlet 420 of the nozzle 400 may be coupled to a pressurized fluid source, such as the pump 110. The outlet region 430 of the nozzle 400 may be submerged in the pond 140, thereby discharging a submerged jet into the pond 140. The nozzle may include a nozzle body 410 forming the external surface of the nozzle 400, an inlet 420, an outlet region 430 with an outlet entry 432 and an outlet exit (e.g., discharge orifice) 434, a flow path 440 situated between the inlet 420 and the outlet region 430, which is bounded by a surface 445 that forms the internal surface of the nozzle 400, and an edge 450. A wall 415 may separate the nozzle body 410 and the surface 445.

FIG. 4A illustrates an axial cross-sectional view of the nozzle 400 as viewed from the inlet 420. As shown, the profile of the nozzle 400 in the axial direction varies in shape along the nozzle body 410, which is elongated as shown. At the inlet 320, the profile is substantially circular, as indicated by the inlet cross-sectional area 465. The circular inlet 420 may facilitate coupling of the nozzle to a manifold, such as the manifold 220, or other conduit. At the outlet 430, the profile of the nozzle is substantially rectangular, as indicated by the outlet cross-sectional area 475.

FIG. 4B illustrates a longitudinal cross-sectional view of the nozzle 400, which may be useful in visualizing the flow path of pressurized fluid from the inlet 420 to the outlet 430. Unlike the nozzle 300, the surface 445 of the nozzle 400 does not substantially conform to the nozzle body 410. This is indicated by the wall 415, the thickness of which progressively decreases from the inlet 420 to the outlet 430, where the thickness of the wall approaches zero. The surface 445 extends from the inlet 420 to the outlet exit 434.

As shown in FIG. 4B, the flow path 440 in the nozzle 400 progressively contracts from the inlet 420 to the outlet 430. The surface 445, which forms a boundary for the flow path 440, may correspond to a monotonically decreasing function intermediate to the inlet 420 and the outlet region 430. As discussed earlier, the nozzle body 410 and the surface 445 may be characterized in terms of contours. In order to transition from the substantially flat contour of the surface 445 in the inlet 420 and the outlet 430, the flow path 440 may include at least one inflection point. In some embodiments, the surface 445 of the nozzle 400 may be smooth in order to reduce energy losses to friction.

The outlet 430 includes an outlet exit 434, as indicated by an edge 450. The edge 450 may form the outlet exit 434 from which the jet is discharged into the algae cultivation pond. The edge 450 may be angled with respect to a vertical dimension. For instance, the nozzle 300 of FIG. 3 indicates an outlet exit 334 that is substantially perpendicular to the flow path 340, and as such may be parallel to a vertical dimension. In contrast, the outlet exit 434 is angled with respect to the flow path 440. The angle between the flow path 440 and the outlet exit 434 is indicated by an angle mark 455. In some embodiments, angles ranging from thirty-five to fifty-five degrees may be represented by the angle mark 455.

The outlet 430 may be modified or otherwise adjusted in order to achieve an objective related to desired resultant jet flow. For instance, if the edge 450 is corrugated, this may increase excitement at the boundary layer at the outlet 430 and facilitate the formation of vortex rings.

The nozzles discussed in the context of FIGS. 3 and 4 may be used in conjunction with the jet circulation system as discussed in the context of FIGS. 1 and 2. Further, the nozzle characteristics discussed above may be modified and/or otherwise manipulated in order to achieve the objectives mentioned above. As such, the nozzles presented in the context of FIGS. 3 and 4 may be viewed as a group, or family of nozzles.

For instance, the surface 345 may smoothly transition from a substantially circular inlet cross-sectional area 365 to a substantially triangular cross-sectional area 375 in the outlet region 330 to the outlet exit 334. Alternatively, the surface 345 may smoothly transition from a substantially circular inlet cross-sectional area 365 to a substantially rectangular cross-sectional area 475 as shown in FIG. 4. Additional features, such as expansion edges, corrugated edges, a swirled surface to impart a swirl to the jet, and the like may be incorporated alone, or in combination with one another, to the nozzles 300 and 400.

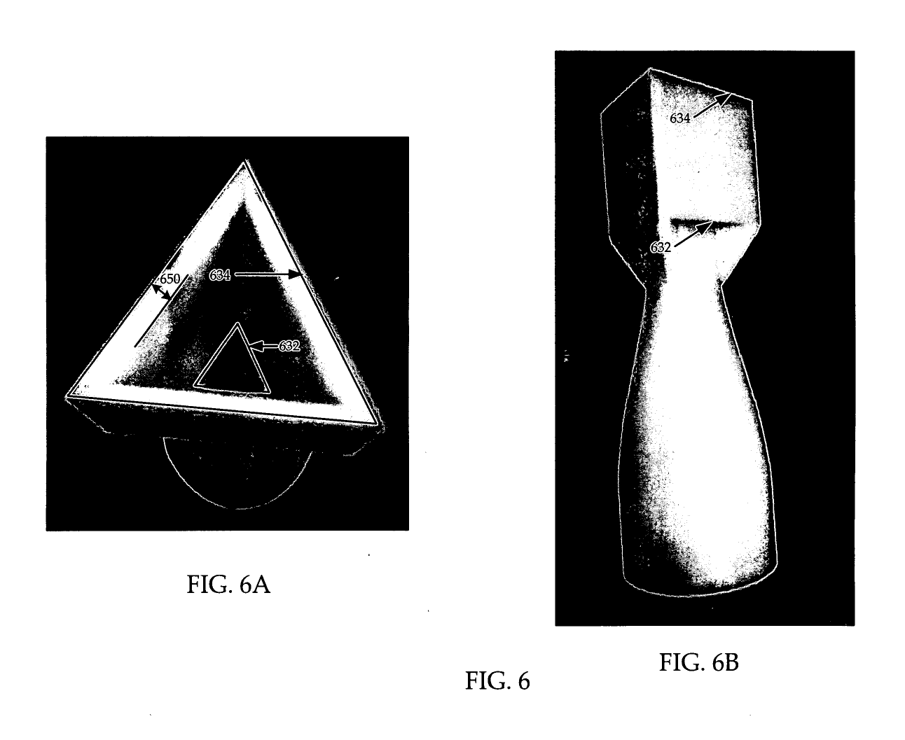

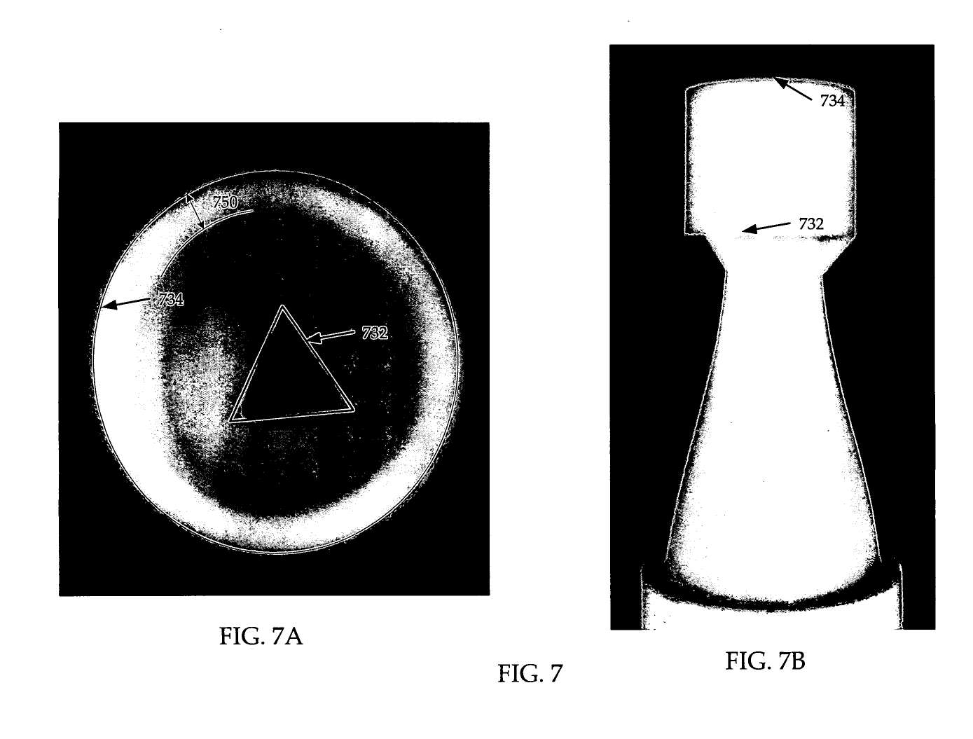

FIGS. 6 and 7 further illustrate embodiments of the outlet region in accordance with the nozzles 300 and 400 discussed in the context of FIGS. 3 and 4 above (e.g., outlet regions 330 and 430). FIG. 6A illustrates an axial cross-sectional view of a nozzle as viewed from the outlet exit 634. A high expansion ratio may play a role in energy efficiency of the nozzle. An expansion ratio may be characterized for instance, as a ratio between the cross-sectional area of the outlet exit to the cross-sectional area of the outlet entry. As illustrated in FIG. 6A, the outlet entry 632 and the outlet exit 634 may include a cross-sectional profile which corresponds to a substantially triangular cross section in the outlet entry 632 and in the outlet exit 634. However, the profile of the outlet region may vary from the outlet entry to the outlet exit. For instance, in FIG. 7A, the cross-section of the nozzle in the outlet entry 732 corresponds substantially to a triangle and to a circle in the outlet exit 734. In some embodiments, the surface (corresponding to surface 345 and/or surface 445 of FIGS. 3 and 4) may correspond to an expansion edge, or convex edge, 650 and 750. The inclusion of expansion edges in a nozzle may be considered when determining an expansion ratio corresponding to the outlet region. FIGS. 6B and 7B correspond to longitudinal views of nozzles illustrated in FIGS. 6A and 7A, respectively.

### EXAMPLES

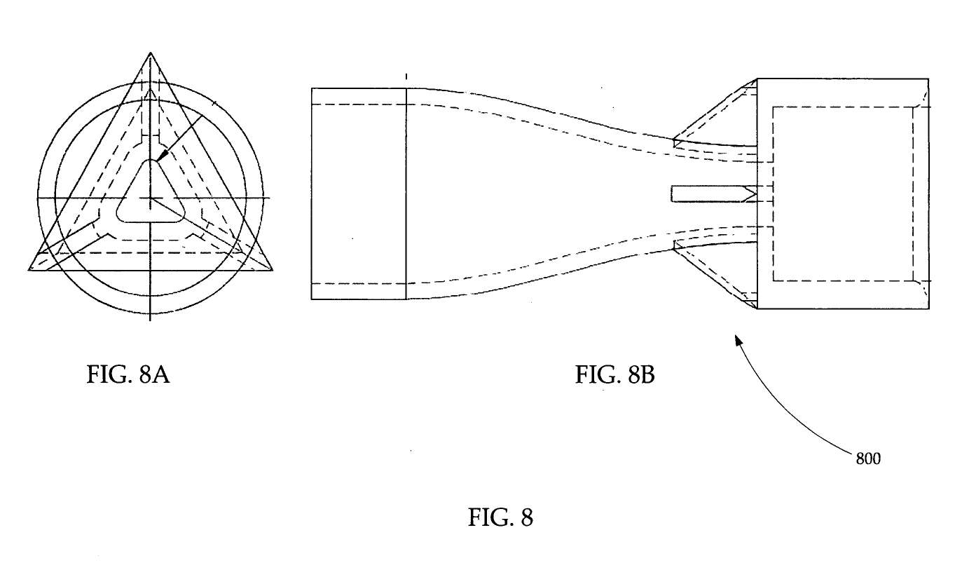

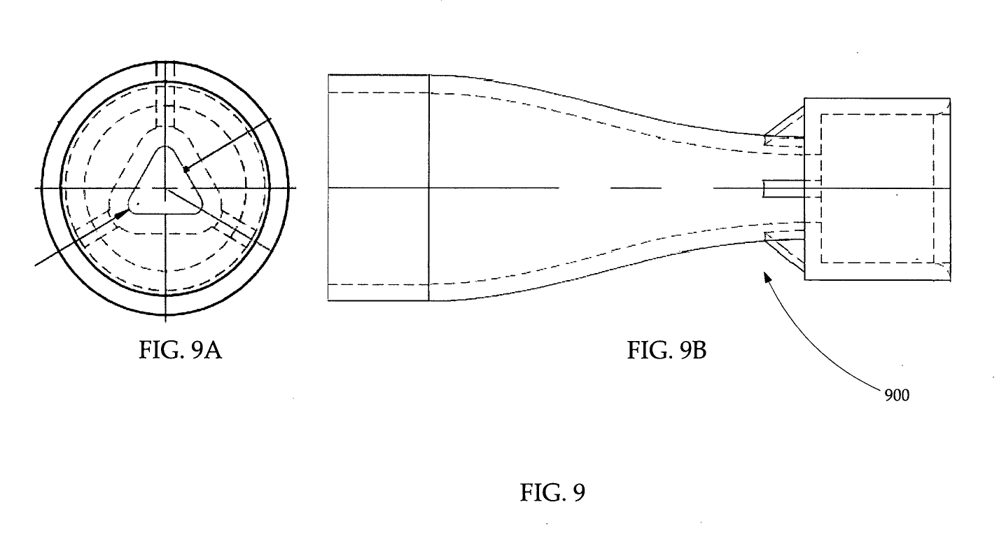

FIGS. 8 and 9 illustrate exemplary nozzles in accordance with FIGS. 3-4 and FIGS. 6-7 described above. FIG. 8 is a CAD drawing of a nozzle 800 which corresponds to the photographs in FIG. 6. FIG. 8A illustrates an axial cross-section of the nozzle 800 as viewed from the nozzle inlet. FIG. 8B illustrates a longitudinal cross-section of the nozzle 800, the outlet region of which includes a high expansion ratio. Similarly, FIG. 9 is a CAD drawing of a nozzle 900 which corresponds to the photographs in FIG. 7. FIG. 9A illustrates an axial cross-section of the nozzle 900 as viewed from the nozzle inlet. FIG. 9B illustrates a longitudinal cross section of the nozzle 900, the outlet region of which includes a high expansion ratio.

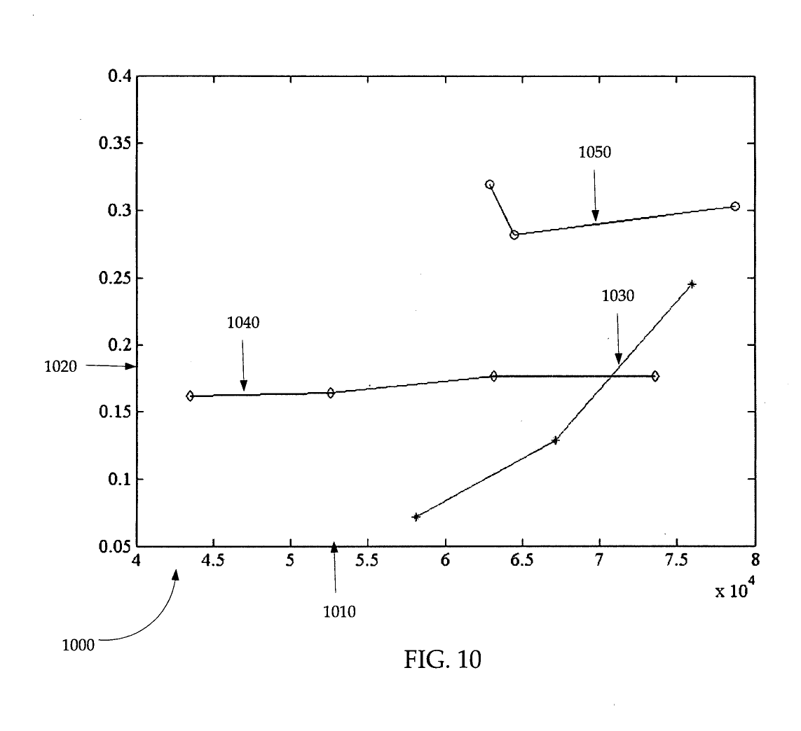

FIG. 10 illustrates, via a chart 1000, experimental data gathered by the inventors from a jet circulation system 100 using nozzles in accordance with the embodiments described in FIGS. 2-9 above. Three nozzle types were used in the experiment, each indicated by lines 1030-1050. Line 1030 represents a control nozzle. Line 1040 represents the performance of a nozzle in accordance with the embodiments described in FIG. 4 (nozzle 400). Line 1050 represents the performance of a nozzle in accordance with the embodiments described in FIG. 3 (nozzle 300). The x-axis 1010 of chart 1000 represents the Reynolds number in each of the nozzles 1030, 1040, and 1050. The Reynolds number may be characterized as the product of flow velocity at an outlet of the nozzle and an equivalent diameter of the nozzle, divided by the kinematic viscosity of water. The y-axis 1020 represents the efficiency of each nozzle. As is indicated by the chart 1000, the highest efficiencies observed were associated with the nozzle 300, represented by line 1050, showing efficiencies as high as 0.3, or 30%. The poorest efficiencies were observed in association with the control nozzle, line 1030 with efficiencies as low as 6%.

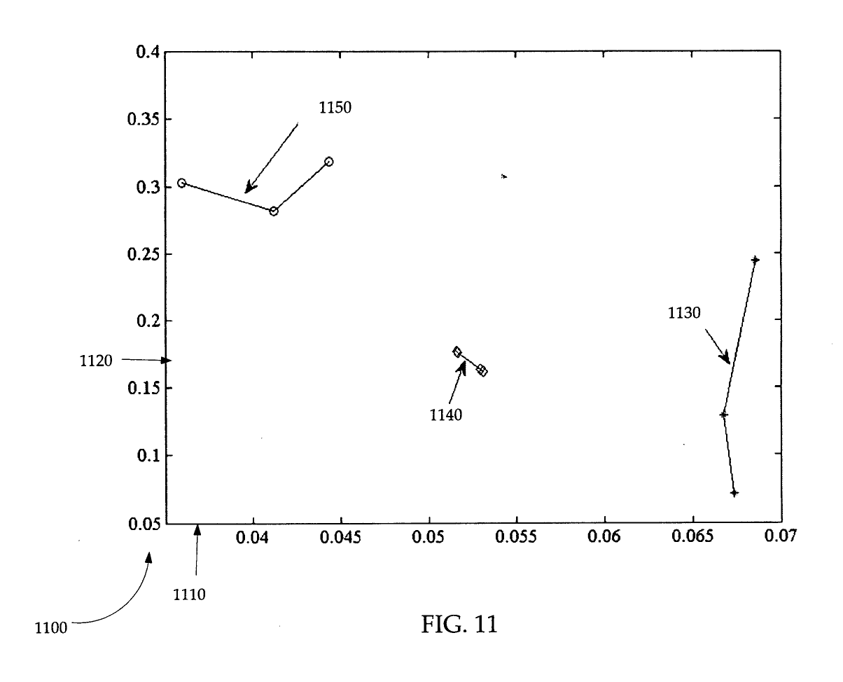

FIG. 11 illustrates, via a chart 1100, experimental data gathered by the inventors from a jet circulation system 100 using nozzles in accordance with the embodiments described in FIGS. 2-9 above. Three nozzle types were used in the experiment, each indicated by lines 1130-1050. Line 1130 represents a control nozzle. Line 1140 represents the performance of a nozzle in accordance with the embodiments described in FIG. 4 (nozzle 400). Line 1150 represents the performance of a nozzle in accordance with the embodiments described in FIG. 3 (nozzle 300). The x-axis 1110 of chart 1100 represents a jet/pond ratio, which may be characterized by a flow rate associated with the jet system (e.g. jet flow), divided by the flow rate in a cross-section of the algae cultivation pond, e.g., the pond 140. The y-axis 1020 represents the efficiency of each nozzle. FIG. 11 illustrates that the jet circulation system 100 may generate circulation in large quantities of fluid, e.g., the pond 140, via small quantities of fluid discharged by the jets. As is indicated by the chart 1100, the lowest jet/pond ratios observed were associated with the nozzle 300, represented by line 1150, showing ratios as low as 0.04, or 4%. Similarly, the highest ratios were observed in association with the control nozzle, represented by line 1130.

The above-described functions and/or methods may include instructions that are stored on storage media. The instructions can be retrieved and executed by a processor. Some examples of instructions are software, program code, and firmware. Some examples of storage media are memory devices, tapes, disks, integrated circuits, and servers. The instructions are operational when executed by the processor to direct the processor to operate in accord with the invention. Those skilled in the art are familiar with instructions, processors, and storage media. Exemplary storage media in accordance with embodiments of the invention are discussed in the context of, for example, the control center 130 of FIG. 1.

Upon reading this paper, it will become apparent to one skilled in the art that various modifications may be made to the systems, methods, and media disclosed herein without departing from the scope of the disclosure. As such, this disclosure is not to be interpreted in a limiting sense but as a basis for support of the appended claims.

What is claimed is:

1. A nozzle for generating fluid flow in an algae cultivation pond, the nozzle comprising:
an inlet;
an outlet region including an outlet entry and an outlet exit, wherein a ratio between an inlet cross-sectional area and an outlet region cross-sectional area is greater than sixteen and wherein a cross-section of the outlet region corresponds to a triangle; and
a smooth surface forming a flow path from the inlet to the outlet exit, the surface corresponding to a polynomial of order five or higher between the inlet and the outlet entry and corresponding to a convex edge between the outlet entry and the outlet exit, wherein a ratio between a length of the surface and an inlet diameter ranges between 1.4 and 2.

2. A nozzle for generating fluid flow in an algae cultivation pond, the nozzle comprising:
a smooth surface forming a flow path from an inlet to an outlet, the surface corresponding to a monotonically decreasing function intermediate to the inlet and the outlet, wherein a ratio of an inlet cross-sectional area to an outlet cross-sectional area is greater than sixteen.

3. The nozzle of claim 2, wherein the ratio of the inlet cross-sectional area to the outlet cross-sectional area is between sixteen and twenty-five.

4. The nozzle of claim 2, wherein the outlet includes an outlet entry and an outlet exit, the surface including an expansion edge between the outlet entry and the outlet exit such that a cross-sectional area of the smooth flow path increases, via the expansion edge, from the outlet entry to the outlet exit.

5. The nozzle of claim 4, wherein the outlet exit corresponds to a triangle.

6. The nozzle of claim 2, wherein the surface is approximately parallel to a horizontal dimension at the inlet.

7. The nozzle of claim 2, wherein the monotonically decreasing function corresponds to a polynomial fourth order or higher.

8. The nozzle of claim 2, wherein a ratio between a length of the surface and an inlet diameter ranges between 1.4 and 2.

9. The nozzle of claim 2, wherein a cross-section of the outlet exit corresponds to a rectangle.

10. The nozzle of claim 2, wherein the outlet includes an outlet entry and an outlet exit, and wherein a cross-sectional area of the outlet exit is greater than a cross-sectional area of the outlet entry.

11. A nozzle for generating fluid flow in an algae cultivation pond, the nozzle comprising:
an inlet located on a first portion of an elongated body; and
an outlet located on a second portion of the elongated body, wherein a cross-section of the internal surface is circular at the inlet and rectangular at the outlet.

12. The nozzle of claim 11, further comprising a flow path from the inlet to the outlet, wherein the outlet includes an outlet exit including an edge angled at approximately thirty-five to fifty-five degrees with respect to a vertical dimension.

13. The nozzle of claim 12, wherein an edge of the outlet exit is corrugated.

14. The nozzle of claim 12, wherein an angle of the flow path is negative with respect to a horizontal dimension.

15. The nozzle of claim 11, wherein a distance between the inlet and the outlet is between ten centimeters and thirty centimeters.

16. The nozzle of claim 11, wherein the nozzle is coupled to a manifold, the manifold configured to receive pressurized fluid from a fluid source.

17. The nozzle of claim 11, wherein the internal surface is configured to impart a swirl to the pressurized fluid.

18. A system for generating fluid flow in an algae cultivation pond, comprising:
at least one nozzle submerged below the surface of an algae cultivation pond and configured to initiate fluid flow in the algae cultivation pond, the nozzle including:
a smooth surface forming a flow path from an inlet to an outlet, the surface corresponding to a monotonically decreasing function from the inlet to the outlet, wherein a ratio of an inlet cross-sectional area to an outlet cross-sectional area is greater than sixteen;
a manifold coupled to the nozzle and to a source of pressurized fluid, the manifold configured to provide pressurized fluid to the nozzle;
a processor; and
a computer-readable storage medium having embodied thereon a program executable by the processor to perform a method for generating fluid flow in an algae cultivation pond, wherein the computer-readable storage medium is coupled to the processor and the pressurized fluid source, the processor executing the instructions on the computer-readable storage medium to:
measure a velocity associated with the generated fluid flow in the algae cultivation pond, and
adjust an energy associated with the pressurized fluid.

19. The system of claim 18, wherein the at least one nozzle forms a portion of an array of nozzles, the array of nozzles configured to generate an array of jets.

20. The system of claim 18, wherein the manifold is configured to provide an equal flow of pressurized fluid to each nozzle of the array of nozzles.

21. The system of claim 18, wherein the nozzle is configured to initiate circulation of fluid in the algae cultivation pond via a jet, such that a head generated by the jet overcomes a head loss of the algae cultivation pond when a velocity of the fluid flow in the algae cultivation pond is at least ten centimeters per second.

22. The system of claim 18, wherein a ratio between a length of the surface and an inlet diameter ranges between 1.4 and 2.
